(19) United States
(12) Patent Application Publication
(10) Pub. No.: US 2019/0296963 A1
(43) Pub. Date: Sep. 26, 2019

(54) ANOMALY DETECTION THROUGH ATTEMPTED RECONSTRUCTION OF TIME SERIES DATA

(71) Applicant: CA, Inc., New York, NY (US)

(72) Inventor: Christopher Phillip Bonnell, Longmont, CO (US)

(21) Appl. No.: 15/933,317

(22) Filed: Mar. 22, 2018

(51) Int. Cl. H04L 12/24; H04L 12/26

(52) U.S. Cl. CPC H04L 41/0622; H04L 43/067

(57) ABSTRACT

To provide adaptive and efficient detection of anomalies within an environment, an anomaly detection system captures time-series metric data from multiple instances of a same component, such as an application, and generates tiles comprising metric values from sequential segments of the metric data. After generating the tile, the system attempts to reconstruct or reproduce metric data for a single application instance using the tiles generated from metric data of the other application instances. If the metric data can be reconstructed, the system determines that the behavior of the application instance is normal or in-line with the other application instances. If the metric data cannot be reconstructed, the system determines that the behavior of the application instance is anomalous or that the application instance is experiencing an anomaly. The system periodically attempts reconstruction of metric data for each of the application instances to provide continuous anomaly detection for the application instances.

### BACKGROUND

The disclosure generally relates to the field of data processing, and more particularly to application monitoring and analysis.

Multiple instances of a same computing application can be executed within container clusters, such container clusters provided through a Container as a Service (CaaS) software, and distributed over a plurality of servers, cloud infrastructures, etc. The performance and health of the application instances can be tracked and viewed through system monitoring software which collects measurements for various metrics from the application instances. The monitoring software may have functionality for generating alerts when application instances fail or when various metric measurements exceed predefined thresholds.

### BRIEF DESCRIPTION OF THE DRAWINGS

Aspects of the disclosure may be better understood by referencing the accompanying drawings.

FIG. 1 depicts an example environment for an anomaly detection system which identifies anomalous application instances through attempted reconstruction of time-series metric data.

FIG. 2 depicts an example tile generator which generates tiles based on metric data for an application instance.

FIG. 3 depicts an example time-series data reconstructor which attempts to reconstruct time-series data for an application instance.

FIG. 4 depicts example operations for generating tiles based on metric data of application instances.

FIG. 5 depicts example operations for anomaly detection through reconstruction of time-series data for an application instance.

FIG. 6 depicts an example computer system with a tile-based anomaly detection system.

### DESCRIPTION

The description that follows includes example systems, methods, techniques, and program flows that embody aspects of the disclosure. However, it is understood that this disclosure may be practiced without these specific details. For instance, this disclosure refers to monitoring application instances in illustrative examples. Aspects of this disclosure can be also applied to other complex systems with multiple components of a same type, such as networks with multiple routers, switches, servers, etc., or mechanical systems instrumented with multiple sensors of same type reporting measurements. In other instances, well-known instruction instances, protocols, structures, and techniques have not been shown in detail in order not to obfuscate the description.

Overview

Virtualization of hardware and software resources has made executing hundreds of instances of a same component a trivial process. Corresponding to this increase in component instances is a drastic increase in the amount of metric data to be analyzed for monitoring the performance and health of the component instances. While comparing metric values to predefined thresholds can aid in monitoring the components, this technique is not responsive to the changing conditions in a system and lacks robustness. To provide adaptive and efficient detection of anomalies within an environment, an anomaly detection system captures time-series metric data from multiple instances of a same component, such as an application, and generates tiles comprising metric values from sequential segments of the metric data. After generating the tile, the system attempts to reconstruct or reproduce metric data for a single application instance using the tiles generated from metric data of the other application instances. If the metric data can be reconstructed, the system determines that the behavior of the application instance is normal or in-line with the other application instances. If the metric data cannot be reconstructed, the system determines that the behavior of the application instance is anomalous or that the application instance is experiencing an anomaly. The system periodically attempts reconstruction of metric data for each of the application instances to provide continuous anomaly detection for the application instances.

### TERMINOLOGY

The description uses the term “metric data” to refer to measurements or values related to various performance indicators or events occurring at component instances, such as application instances. The term “metric” refers to a type or standard of measurement. Metrics can include performance metrics such as central processing unit (CPU) load, memory usage, disk input/output operations (disk I/O or TOPS), Hypertext Transfer Protocol (HTTP) requests, bandwidth usage, etc., and can also include application or domain specific metrics such as a number of authentication requests for an application which includes a service for authenticating users. The data of the metrics includes the measurements or values recorded overtime for each of the metric types. This data may be referred to as “time-series data” since the recorded measurements are temporally consecutive.

The description uses the term “anomaly” to refer to an abnormal behavior or condition of an application instance. An application instance is anomalous if the behavior or metric data of the application instance deviates from normal or expected values or parameters. The normal or expected values or behaviors for an application instance are determined or inferred based on the values and behaviors of other instances of a same application. If, for example, the metric values or behaviors of an application instance have been experienced by at least one other application instance in a system, then it can be inferred that the application instance is behaving as expected. If, however, the metric values or behaviors have not been replicated by any other application instance, then the application instance is determined to be anomalous or to be experiencing an anomaly.

### Example Illustrations

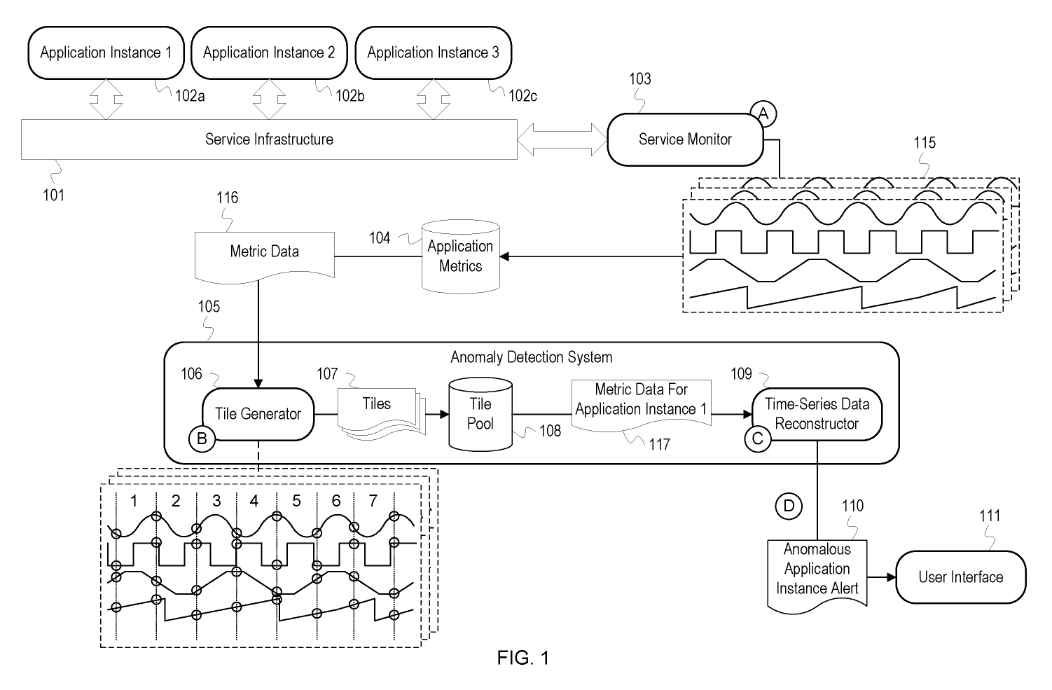

FIG. 1 depicts an example environment for an anomaly detection system which identifies anomalous application instances through attempted reconstruction of time-series metric data. FIG. 1 depicts a service infrastructure 101 which hosts an application instance 1 102a, an application instance 2 102b, and an application instance 2 102c (collectively referred to as “application instances 102”). A service monitor 103 communicates with the service infrastructure 101 to receive data related to the application instances 102. FIG. 1 also depicts an anomaly detection system 105 that includes a tile generator 106, a tile pool 108, and a time-series data reconstructor 109 (“data reconstructor 109”). The anomaly detection system 105 provides alerts to a user interface 111. The service monitor 103 and the data reconstructor 109 are communicatively coupled to an application metrics database 104.

The application instances 102 are executing instances or instantiations of a same application. For example, each of the application instances 102 may be a front-end interface for accessing a database. Having multiple instances of an application allows for load balancing and redundancy in the event of application instance failures. Each of the application instances 102 may be containerized or isolated in a way that each of the application instances 102 runs independently of the others, even if they are executing on a same server. The service infrastructure 101 includes a variety of hardware and software resources to enable execution of the application instances 102. The service infrastructure 101 provides memory, processor(s), and storage for the application instances 102 and can also include a host operating system running a hypervisor to provide guest operating systems, binaries, and libraries for the application instances 102. The service infrastructure 101 also includes software such as agents/probes for monitoring and reporting, periodically or on-request, metric data for the application instances 102.

At stage A, the service monitor 103 receives time-series metric data 115 for each of the application instances 102 from the service infrastructure 101. The service monitor 103 is a software service which executes independently of the application instances 102 and the service infrastructure 101 to monitor the application instances 102 and collect the metric data 115. The service monitor 103 may periodically request the metric data 115 regarding the application instances 102 through the service infrastructure 101 or receive the metric data 115 in a data stream from the service infrastructure 101. The metric data 115 includes measurements recorded over time for various metrics of the application instances 102. FIG. 1 depicts the received measurements of the metric data 115 as a collection of continuous waves or signals to illustrate that the measurements constitute a set of time series data. In actuality, the metric data 115 comprises metrics with measurements sampled at various intervals. For example, the CPU load for an application instance may be measured every second. The metric data 115 includes a set of metric measurements for each of the application instances 102. For example, the metric data 115 may include memory usage measurements for each of the application instance 1 102a, the application instance 2 102b, and the application instance 3 102c. Since the application instances 102 are each instances of a same application, the same metrics are available for each of the application instances 102. The service monitor 103 stores the metric data 115 in the metrics database 104. Each metric measurement in the metric data 115 may be stored as a tuple comprising a metric identifier/key, a metric measurement/value, a timestamp, and an application instance identifier.

At stage B, the tile generator 106 retrieves metric data 116 from the metrics database 104 and generates tiles 107 based on the metric data 116. The metric data 116 includes metric measurements for each of the application instances 102; however, the metric data 116 may be a subset of the metric data 115. The tile generator 106 may submit a query to the metrics database 104 to request metric data for a specific time period, request a number of most recent entries to the metrics database 104, request all new entries to the metrics database 104 since a previously retrieved entry, etc. In some instances, not all collected metrics will be used in tiles, so the tile generator 206 may request only particular metrics. The tile generator 206 may focus on particular metrics since certain metrics may be more likely to indicate an anomaly than other metrics or may be more likely to be associated with a severe anomaly. For example, bandwidth usage or HTTP requests metrics can help determine whether an application instance may respond slowly while memory usage or CPU load metrics may be more helpful in determining whether a total failure of an application instance is likely.

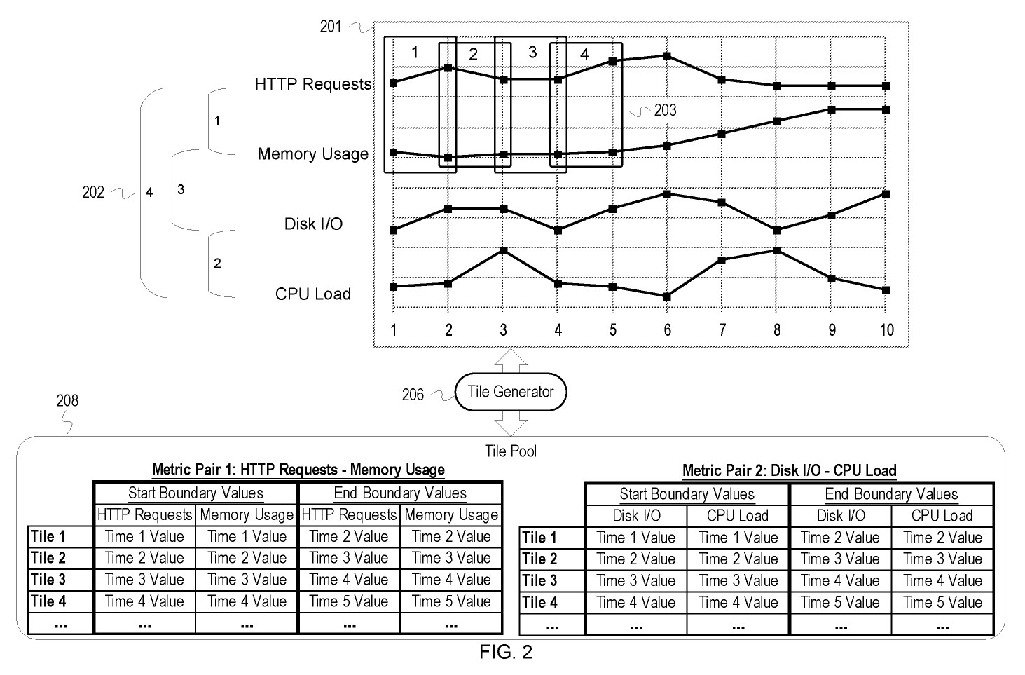

To generate tiles, the tile generator 106 divides the metric data 116 for each of the application instances into equal segments or slices. In FIG. 1, for example, the metric data 116 is divided into segments 1-7. Segments may be based on a time interval such as every 1 second, 5 seconds, etc. or may be based on a number of metric measurements, such as every third recorded measurement. Next, the tile generator 106 identifies boundary values for each of the segments. In FIG. 1, the boundary values are shown as circles which identify the metric measurements recorded at points corresponding to the beginning and end of a segment. A tile is a set of metric values corresponding to a start and an end of a segment of metric data. The values used for the tiles may be normalized, rounded, filtered through a sigmoid function, etc. to increase the chances of matching tile values during reconstruction at stage C below. For example, if a metric measurement is indicated as a floating point value, the metric measurement may be rounded to the nearest tenth or hundredth decimal place. Additionally, as illustrated in more detail in FIG. 2, data for multiple metrics may be grouped together to create multi-dimensional tiles. For example, CPU load, memory usage, and disk TOPS metrics may be grouped to create a tile based on measurements from each of the three metrics. After generating the tiles 107, the tile generator 106 stores the tiles 107 in the tile pool 108. The tile pool 108 may be a structure in memory of the anomaly detection system 105 or may be a database or other storage device. Each tile may be associated with an application instance identifier and metric identifiers for the one or more metric values indicated in the tile. The boundary values for a segment may be stored as an ordered pair representing a beginning and end value, respectively, e.g. (x, y).

At stage C, the data reconstructor 109 retrieves metric data 117 for the application instance 1 102a from the tile pool 108. The metric data 117 comprises one or more temporally sequential sets of tiles generated by the tile generator 106 from time-series metric data of the application instance 1 102a. Each set of tiles corresponds to one or more metric types for the application instance 1 102a. The metric data 117 may include tiles corresponding to metric data of a most recent time period, such as the previous ten seconds, or may include a specified number of new or recently added tiles for the application instance 1 102a. Alternatively, in some implementations, if tiles for recent metric data of the application instance 1 102a have not been generated, the data reconstructor 109 retrieves recent metric data from the metrics database 104. The data reconstructor 109 may then generate tiles from the recent metric data in a manner similar to the tile generator 106 in order to prepare the recent metric data for attempted reconstruction.

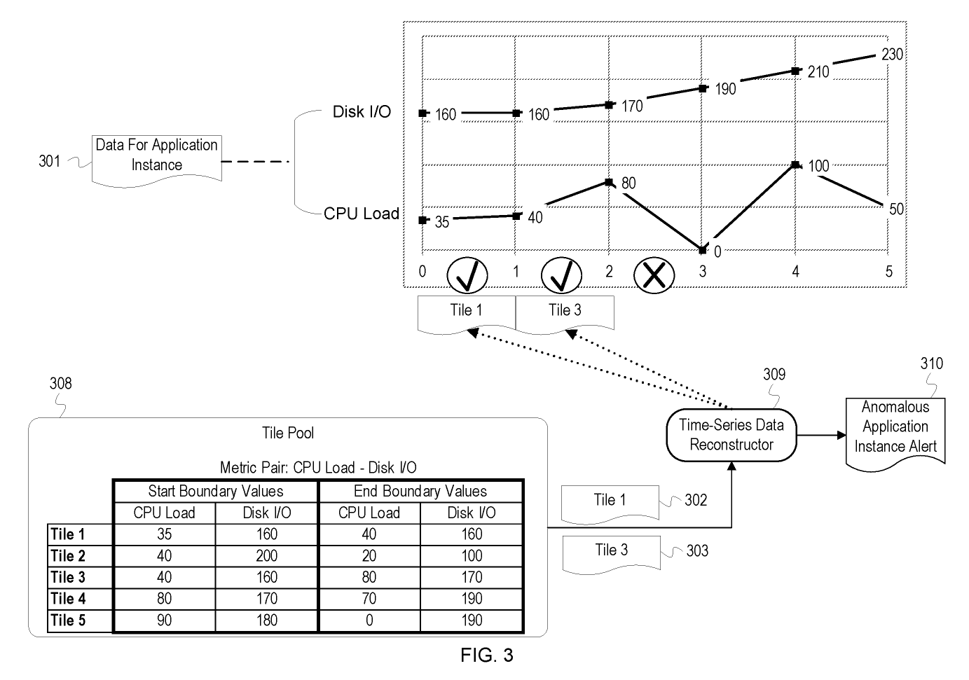

The data reconstructor 109 attempts to reconstruct or reproduce the metric data 117 using tiles in the tile pool 108 corresponding to the other application instances, i.e. the application instance 2 102b and the application instance 3 102c. Tiles in the tile pool 108 corresponding to the application instance 1 102a are excluded when reconstructing the metric data 117, although, in some implementations, tiles of the application instance 1 102a not represented in the metric data 117 may be used. The data reconstructor 109 iterates through each of the tiles in the metric data 117 and attempts to find a matching tile in the tile pool 108. Two tiles match if the boundary values indicated in the tiles are the same. The reconstruction process is described in more detail in FIG. 3. If a matching tile is found for each tile, the data reconstructor 109 determines that the behavior of the application instance 1 102a is normal. If a matching tile cannot be found for each tile in the metric data 117, the data reconstructor 109 determines that the application instance 1 102a is anomalous or is experiencing an anomaly.

At stage D, the data reconstructor 109 communicates an anomalous application instance alert 110 to the user interface 111 in response to being unable to reconstruct the metric data 117 for the application instance 1 102a. The user interface 111 may be part of a software management or monitoring system used by administrators. In response to receiving the alert 110 for an anomaly, the user interface 111 may display an alert to notify the administrator that the application instance 1 102a is experiencing an anomaly. In some implementations, a monitoring system may automatically terminate the application instance 1 102a and instantiate a new application instance as a replacement. The data reconstructor 109 may also provide details about the anomaly such as which metrics were unable to be reconstructed or provide the metric data indicated in the metric data 117.

The operations of stage C are repeated for the application instance 2 102b and the application instance 3 102c to determine whether those application instances are behaving normally or are experiencing an anomaly. Moreover, the operations of stage B and stage C may be repeated for each of the application instances 102 periodically or after a specified amount of new metric data is added to the metrics database 104. In some implementations, tiles generated from new metric data at stage B may not be added to the tile pool 108 until after reconstruction of the metric data for each of the application instances 102 has been attempted. If metric data for an application instance cannot be reconstructed, the tiles generated from the metric data are not added to the tile pool 108 so that the tile pool 108 does not contain tiles with anomalous metric values. Alternatively, in some implementations, the tiles generated from metric data for which an anomaly was detected may be marked as anomalous and stored in a separate tile pool. After failing to reconstruct other metric data, the data reconstructor 109 may determine if any of the anomalous tiles match the other metric data to determine whether the currently detected anomaly is similar to a previously encountered anomaly.

FIG. 2 depicts an example tile generator which generates tiles based on metric data for an application instance. FIG. 2 depicts a tile generator 206 which generates and stores tiles in a tile pool 208. The tile generator 206 generates tiles based on received metric data 201.

The metric data 201 includes metric measurements collected from a single application instance. The metrics include HTTP requests, memory usage, disk I/O and CPU load each with measurements collected at times 1-10. The time instances 1-10 also represent the boundaries of segments to be used for generating tiles. The tile generator 206 may be configured with a segment size of 5 seconds and divide the metric data 201 accordingly beginning from time 1, resulting in 5-second segments from times 1-2, 2-3, 3-4, etc. In some instances, measurements for each of the metrics may not have been sampled or collected at times corresponding to the segment boundaries. The CPU load metric, for example, may have been measured at a time of 1 minute and 10 seconds, and the memory usage may have been measured at a time of 1 minute and 11 seconds. The tile generator 206 may shift the measurements so that the measurements align at the segment boundaries at time instances 1-10. Additionally, measurements may be collected at different frequencies, such as every 10 seconds for disk I/O versus every 20 seconds for HTTP requests. If a segment size is selected to be 10 seconds, the tile generator 206 may use interpolation on the disk I/O measurements to determine metric values at 10 second intervals between each of the 20 second measurements for the disk I/O metric.

FIG. 2 also depicts metric pairs 202. Metrics may be grouped or paired so that a tile includes boundary values from multiple metrics for a given segment. Grouping the metrics improves the anomaly detection process by ensuring that a tile series cannot be easily reconstructed and providing context for metric measurements. For example, a high CPU load metric value may seem normal in isolation; however, when considered in context, such as when paired with a low HTTP requests metric value, it can become apparent that the CPU load metric should not be high considering the few requests. During the reconstruction process, a tile that has a high CPU load value paired with a low HTTP request value will likely not be found thus allowing the anomaly to be discovered; whereas, if the CPU load metric was not paired, a tile with a high CPU load metric would likely still be found. The metric pairs 202 include four overlapping pairs of metrics: (1) HTTP requests and memory usage, (2) disk I/O and CPU load, (3) memory usage and disk I/O, and (4) HTTP requests and CPU load. Other pairings or groupings of metrics are possible. For example, additional pairs of metrics may be added so that all possible combination of metrics pairs are represented. Additionally, the tile generator 206 may generate tiles of various group sizes, e.g. some tiles based on metric pairs, some tiles based on a trio of metrics, etc.

The tile generator 206 generates tiles by identifying values for each of the metric pairs 202 at the boundaries of the segments. The tile pool 208 in FIG. 2 depicts example tiles for the first two metric pairs 202 of HTTP requests-memory usage and disk I/O-CPU load. The table titled “Metric Pair 1” in the tile pool 108 shows four tiles generated based on the pairing of HTTP requests and memory usage metrics. As shown in the table, each tile includes values for the metrics at time instances corresponding to the segment boundaries. Tile 1, for example, includes start boundary values for HTTP requests and memory usage at time 1 and end boundary values for HTTP requests and memory usage at time 2. Tile 2 continues with start boundary values from time 2 and end boundary values from time 3. The tiles 1-4 are graphically illustrated for explanation purposes by the example tiles 203. The values included in each tile are outlined by the rectangles of the example tiles 203. The tile pool 108 includes a depiction of a table for the “Metric Pair 2” with tiles that contain values of the disk I/O and CPU load metrics. Although not depicted, the tile generator 206 creates similar tables for the other metric pairs in the metric pairs 202.

For simplicity, FIG. 2 depicts metric data 201 for a single application instance. Metric data for other application instances is collected over a same time period, and the tile generator 206 similarly generates tiles using a same segment size and the same metric pairs 202 or grouping scheme for the metric data of each application instance. For example, a system may include 100 instances of a same application which causes 100 sets of metric data to be collected and 100 sets of tiles to be generated. When storing a tile in a tile pool, the tile generator 206 may determine if an identical tile is already stored to avoid storing duplicate tiles. If an identical tile is already stored, the tile generator 206 can associate the existing tile with an identifier for the additional application instance so that the tile is associated with identifiers for each application instance which experienced the same metric data. The tile generator 206 may, for example, append the identifier to a list of application instance identifiers in an entry for the tile in the tile pool 208.

FIG. 3 depicts an example time-series data reconstructor which attempts to reconstruct time-series data for an application instance. FIG. 3 depicts a time-series data reconstructor 309 which retrieves tiles from a tile pool 308 for reconstructing time-series data 301 of an application instance. The tile pool 308 includes tiles generated based on metric data retrieved from other application instances. In FIG. 3, for ease of explanation, the tile pool 308 only depicts tiles for a first metric pair based on CPU load and disk I/O metrics. Similarly, the time-series data 301 only includes metric measurements for the same metric pair. The data reconstructor 309 may have retrieved the time-series data 301 from the tile pool 308 or from a database of application instance metrics. For example, the data reconstructor 309 may have queried the tile pool 308 to retrieve the five most recent tiles for the application instance and compiled the time-series data 301.

The data reconstructor 309 attempts to reconstruct the time-series data 301 using tiles from the tile pool 308. The data reconstructor 309 selects a first metric value from the time-series data 301 and searches the tile pool 308 to identify tiles which have a value that matches the first value. For example, the data reconstructor 309 may select the CPU load value of 35 and search the tile pool 308 to identify tiles which also have a starting CPU load value of 35. In FIG. 3, the “Tile 1” has a starting CPU load value of 35. The data reconstructor 309 then determines whether the starting disk I/O value of 160 from the time-series data 301 matches the “Tile 1.” The data reconstructor 309 continues this process and compares the end boundary values of CPU load and disk I/O between the time-series data 301 and the “Tile 1.” After determining that each of the values match, the data reconstructor 309 retrieves the tile 1 302 from the tile pool 308 to begin reproducing the time-series data 301. Alternatively, in some implementations, the data reconstructor 309 simply indicates that the tile exists and does not retrieve tile data from the tile pool 308.

The data reconstructor 309 continues the reconstruction process by identifying tiles which satisfy the segment of the time-series data 301 from time instances 1-2. The data reconstructor 309 searches the tile pool 308 to identify tiles which have a start CPU load value of 40, which in FIG. 3 is “Tile 2” and “Tile 3.” Upon comparing the remaining values, the data reconstructor 309 determines that “Tile 3” is a match and appends the tile 3 303 to the tile 1 302. The data reconstructor 309 continues the reconstruction process by attempting to identify tiles which satisfy the values of the time-series data 301 for the segment from time instances 2-3. The data reconstructor 309 determines that, although the “Tile 4” has a correct starting CPU load value of 80, no tiles match all four metric values for the segment from 2-3. As a result, the data reconstructor 309 determines that the time-series data 301 cannot be reconstructed and generates an anomalous application instance alert 310 for the application instance corresponding to the time-series data 301.

The reconstruction process example described above relied on exact matches of metric values; however, in some implementations, values within a threshold difference, e.g. plus or minus five, may be deemed a match. Moreover, in some implementations, temporal constraints may be applied in addition to the metric value matching. For example, the tile 1 302 may only be considered a match if it corresponds to a same real-time or run-time period as the time instances 0-1. Also, the tile 3 303 may only be considered a match if the tile 3 303 occurred sequentially in time or at a same application instance as the tile 1 302.

The computational efficiency of the reconstruction process can be improved in a variety of ways. Index structures for searching the tile pool 308 may be generated. For example, one or more binary search trees or B-trees which use the metric values as keys can improve the time in which tiles with at least one matching metric value are found. Additionally, the metric values in a tile may be combined and hashed or fingerprinted before being added to the tile pool 308. In such an implementation, the data reconstructor 309 may hash metric values for segments from the time-series data 301 and search the tile pool 308 using the hash. Furthermore, Bloom filters may be used to determine whether a tile exist in the tile pool 308. The fact that Bloom filters give false positives may be ignored in instances where a “best-effort” reconstruction is sufficient.

If the tile pool 308 includes any tiles corresponding to the same application instance as the time-series data 301, the data reconstructor 309 excludes those tiles from the reconstruction process. The data reconstructor 309 can query the tile pool 308 in a manner which excludes tiles corresponding to the application instance or otherwise filter the tile pool 308 to ensure that no tiles for the same application instance are used. In some implementations, tiles from the same application instance occurring before the time instant 0 in the time-series data 301 may be used during reconstruction.

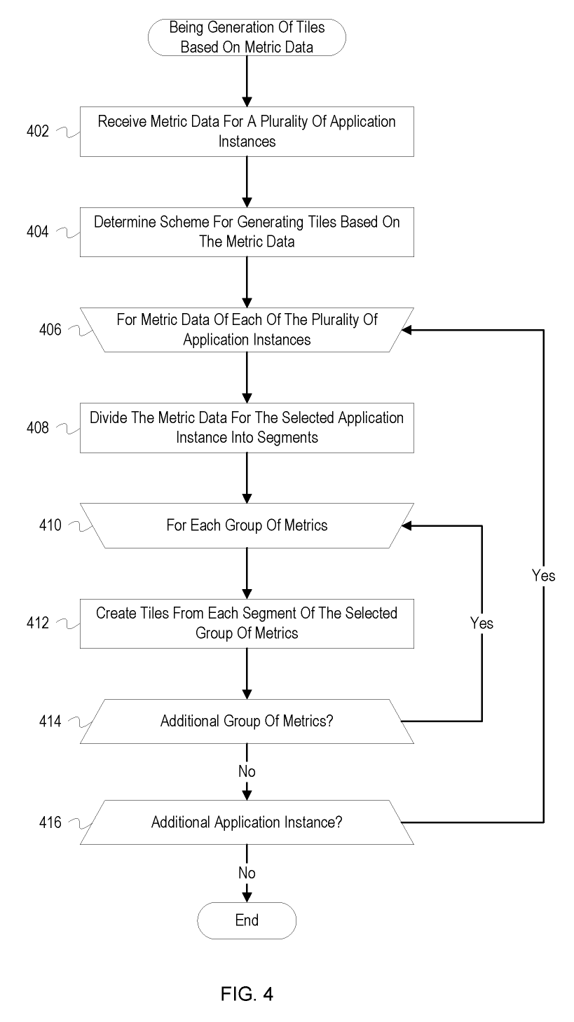

FIG. 4 depicts example operations for generating tiles based on metric data of application instances. FIG. 4 refers to an anomaly detection system as performing the operations for naming consistency with FIG. 1, although naming of software and program code can vary among implementations.

An anomaly detection system (“system”) receives metric data corresponding to a plurality of application instances (401). The system can obtain the metric data by polling the application instances, subscribing to metric data updates from a monitoring service, querying a metric data database, etc. The system can be configured to retrieve specified types of metrics which may be conducive to detecting anomalies. Additionally, the system may be configured to sample metric data at periodic intervals. For example, the system may retrieve a previous 20 seconds of metric data every minute.

The system determines a scheme for generating tiles based on the metric data (404). A tile scheme includes parameters for slicing/segmenting the metric data and grouping metric data. The system may be configured with a tile scheme which indicates a segment size, e.g. 3 seconds or every 5 data points, and specifies metric groupings, e.g. specific pairs or trios of metrics. The system can also determine a segment size based on a sample rate of the metric data. For example, if metrics are recorded at 2 second intervals, the system may double the sample rate and determine that a 4 second segment size should be used. Similarly, for metric groupings, the system can determine a grouping size based on a number of available metric types. For example, if there is a relatively larger number of metrics, the system may use a larger group size, e.g. groups of 5 metrics. After a tile scheme is determined, the system stores the parameters so that future tile generation is consistent with the determined parameters.

The system begins processing metric data for each of the plurality of application instances (406). The system iterates through the metric data for each of the application instances. The application instance whose metric data is currently being processed is hereinafter referred to as “the selected application instance.”

The system divides the metric data for the selected application instance into segments (408). The system slices or segments the metric data in accordance with the determined segment size. Segmenting the metric data involves determining time values for the boundaries of the segments. The system can determine a starting time for the metric data as a first boundary and determine subsequent boundaries based on the segment size. For example, if a first metric value is recorded at a time of 1 minute and 30 seconds, the next boundary may be located at a time of 1 minutes and 35 seconds if the segment size is 5 seconds. Other techniques for segmenting the metric data may be possible depending on a format or structure of the metric data. For example, if the metric data is in a multi-dimensional array, the segment boundaries can be indicated using indexes of the array, e.g. 0, 5, 10, etc. The system may create a list of time values or other indications of the segment boundaries. Also, as part of segmenting the metric data, the system may time shift data for one or more of the metrics so that recorded metric values align at boundaries of the segments.

The system begins generating tiles for each group of metrics in the metric data of the selected application instance (410). The system iterates through each grouping of metrics determined at block 404. The group of metrics for which tiles are currently being generated is hereinafter referred to as “the selected group of metrics.”

The system creates tiles from each segment of the selected group of metrics (412). The system captures values for each metric in the selected group of metrics at start and end boundaries of each segment. The boundary values for each of the segments are stored as tiles along with identifiers for the selected application instance and the metrics in the selected group of metrics. In some implementations, the tiles may also be associated with a timestamp. If the tile pool is a relational database, tiles for the selected group of metrics may be stored in their own table in which tiles generated for the selected group of metrics across the plurality of application instances are stored. If the tile pool is a collection of hash values or a fingerprint database, the system may hash the tile prior to storage.

The system determines whether there is an additional group of metrics (414). If there is an additional group of metrics, the system selects the next group of metrics (410).

If there is not an additional group of metrics, the system determines whether there is an additional application instance (416). If there is an additional application instance, the system selects the next application instance (406). If there is not an additional application instance, the process ends.

The above operations of FIG. 4 may be triggered each time new metric data is received for the plurality of application instances. To ensure space for new tiles, the system may keep generated tiles in a tile pool for a specified retention period. For example, tiles corresponding to metric data older than 24 hours may be purged from the tile pool.

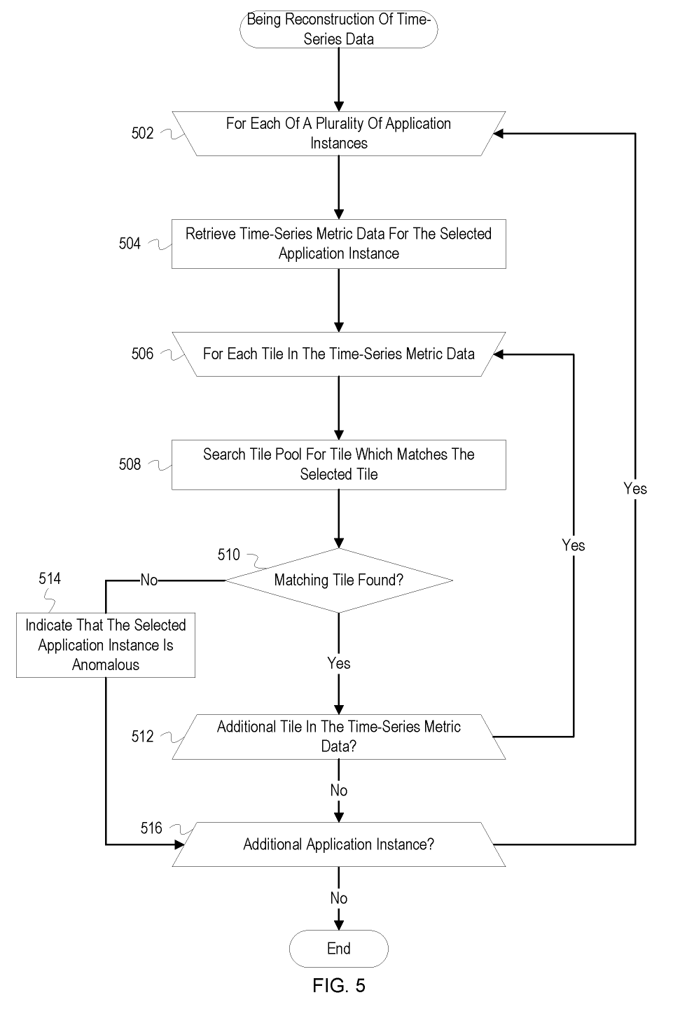

FIG. 5 depicts example operations for anomaly detection through reconstruction of time-series data for an application instance. FIG. 5 refers to an anomaly detection system as performing the operations for naming consistency with FIG. 1, although naming of software and program code can vary among implementations.

An anomaly detection system (“system”) begins monitoring operations for a plurality of application instances (502). To determine whether any of the application instances are experiencing anomalies or behaving anomalously, the system iterates through each of the application instances to attempt reconstruction of metric data for the application instances. The application instance for which the system is currently attempting reconstruction is hereinafter referred to as “the selected application instance.”

The system retrieves time-series metric data for the selected application instance (504). The system can retrieve metric data for a specified time interval, e.g. last 10 seconds, or retrieve a specified amount of metric data, e.g. 10 megabytes, previous 20 measurements, 50 tiles, etc. If tiles for the metric data of the selected application instance have been generated, the system can retrieve tiles for the selected application instance from the tile pool. When retrieving the tiles, the system retrieves a number of time-sequential tiles for the selected application instance from each available group of metrics. For example, if the system is configured to retrieve 10 seconds of metric data, the system retrieves a number of tiles constituting 10 seconds of metric data from each set of tiles based on different metric groupings, i.e. the determined number of tiles are retrieved from a CPU load-memory usage metric group and also from a disk I/O-HTTP requests group. If tiles for the metric data have not been generated, the system may retrieve the metric data by polling the selected application instance or querying a metric database/log. The system then generates tiles based on the metric data using a same tile scheme as was used to generate tiles in the tile pool. In either instance, the retrieval of time-series metric data results in metric data comprising sets of time-sequential tiles corresponding to the specified groups of metrics.

The system begins attempted reconstruction of the time-series metric data (506). The system iterates through each tile in the time-series metric data. The system may start with a set of tiles based on a first group of metrics and iterate through each tile in the first group before continuing to tiles of a second group. In some implementations, the system may begin with iterating through a first tile from each set of tiles, then continue to second tiles, third tiles, etc. The tile which the system is currently attempting to reconstruct is hereinafter referred to as “the selected tile.”

The system searches the tile pool for a tile which matches the selected tile (508). The system searches the tile pool in accordance with a structure of the tile pool. If the tile pool is a database, the system may construct a query using metric values of the selected tile and execute the query on a table corresponding to the selected tile's group of metrics. If the tile pool is a collection of hash values, the system may hash the selected tile and determine if a matching hash exists. The system may also search the tile pool utilizing available index structures.

The system determines whether a matching tile was found (510). If the search of the tile pool produced a result, the system determines that a matching tile was found. If the search returned no results, the system determines that no matching tile exists. In some implementations, even if the search produced a tile, the system may analyze other criteria to determine whether the tile is considered a match for the selected tile. For example, if the returned tile is older than a threshold age, the system may determine that the tile is not a match for the selected tile.

If a matching tile was found, the system determines whether there is an additional tile in the time-series metric data (512). If there is an additional tile, the system selects the next tile (506).

If a matching tile was not found, the system indicates that the selected application instance is anomalous (514). Since a matching tile could not be found, the system failed to reconstruct the time-series data and determines that the data for the selected application instance contains anomalous metric values. As a result, the system can display a message on a user interface or notify monitoring software that the selected application instance is experiencing an anomaly. In some implementations, the system continues the reconstruction process until reconstruction has been attempted for all groups of metrics in the time-series data. After attempting reconstruction of all groups, the system can indicate which groups were successfully reconstructed and which groups were not able to be reconstructed. The system may perform additional analysis on anomalous groups (i.e., groups of metrics which could not be reconstructed) to identify a metric which likely prevented reconstruction of the metric groups. In some implementations, the system may not determine that the selected application instance is anomalous unless metric data for a threshold number of groups of metrics could not be reconstructed. For example, if the metric data comprises 10 metric groups, the system may only indicate an anomaly when reconstruction failed for at least 8 of the groups.

If there is not an additional tile or after indicating that the selected application is experiencing an anomaly, the system determines if there is an additional application instance (516). If there is an additional application instance, the system selects the next application instance for anomaly detection (502). If there is not an additional application instance, the process ends.

The above description assumes that all application instances are instances of a same application. Similar operations can be performed to monitor application instances corresponding to different applications. For example, each application may be assigned its own tile pool for storing all tiles generated from corresponding application instances. In this implementation, the operations of FIG. 4 are repeated for each different application and its instances. Similarly, the operations of FIG. 5 can be repeated to perform anomaly detection for instances of each different application. Furthermore, if a single application has a relatively large number of instances, the application instances may be divided into groups for purposes of anomaly detection. For example, if there are 200 application instances, a first group of 100 application instances may be monitored by a first anomaly detection system, and a second group of 100 application instances may be monitored by a second anomaly detection system. In some implementations, application instances may be grouped based on which server they are executing. For example, 50 application instances executing on a first server may be in a first group, and 25 application instances executing on a second server may be in a second group.

Variations

FIG. 1 is annotated with a series of letters A-D. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 408 and 412 of FIG. 4 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Some operations above iterate through sets of items, such as metric data for application instances, groups of metrics, tiles. In some implementations, items may be iterated over according to an ordering of the items, an indication of item importance, an item's timestamp, etc. Also, the number of iterations for loop operations may vary. Different techniques for processing the items may require fewer iterations or more iterations. For example, multiple items may be processed in parallel. Additionally, in some instances, not all items may be processed. For example, for application instances, only a number of application instances may be monitored at each monitoring interval. Ten application instances from a plurality of application instances may be randomly selected at a first execution of the anomaly detection process, and another ten application instances may be subsequently, e.g. 1 minute later, selected for anomaly detection.

The above operations focus on analyzing metric data collected from the application instances; however, similar operations can be applied to analyzing other components within the system, such as servers, operating systems, storage devices, etc. For example, if the application instances execute across multiple hypervisors, the anomaly detection system can also collect metric data from each of the hypervisors and similarly perform anomaly detection for the hypervisors as if they were application instances. The term “component” as used herein encompasses both hardware and software resources. The term component may refer to a physical device such as a computer, server, router, etc.; a virtualized device such as a virtual machine or virtualized network function; or software such as an application, a process of an application, database management system, etc. A component may include other components. For example, a server component may include a web service component which includes a web application component.

In FIG. 1, the application instances 102 are depicted as being comprised of a single module or container. However, the application instances 102 may each comprise a group/pod of containers running services of the overall application. Additionally, the application instances 102 may be distributed across multiple service infrastructures from which the service monitor 103 collects metric data. In some implementations, the anomaly detection system 105 may be part of the service monitor 103 or may communicate directly with the service infrastructure(s) to retrieve metric data for application instances.

When retrieving metric data for an application instance(s) over a time period, the anomaly detection system may specify whether the time period indicates a real-time period or a time period based on a run-time of the application instance(s). A real-time period is a time period corresponding to a time of day, such as 10:05 A.M. to 10:10 A.M., and a run-time period corresponds to a time period relative to when an application instance began execution. For example, a run-time for the tenth minute of an application instance's execution time may be specified as 00:09:00-00:10:00, assuming the starting time was 00:00:00. Since the application instances may begin execution at different times of the day, requesting data from a run-time period results in metric data from different real-time periods across the application instances. Metric data from run-time periods may be useful for analyzing certain metrics, such as an application instance's memory usage after one hour of executing. When attempting reconstruction of time-series data, the system may limit the tile pool to tiles which include metric values collected within a same run-time period as the time-series data.

The variations described above do not encompass all possible variations, implementations, or embodiments of the present disclosure. Other variations, modifications, additions, and improvements are possible.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

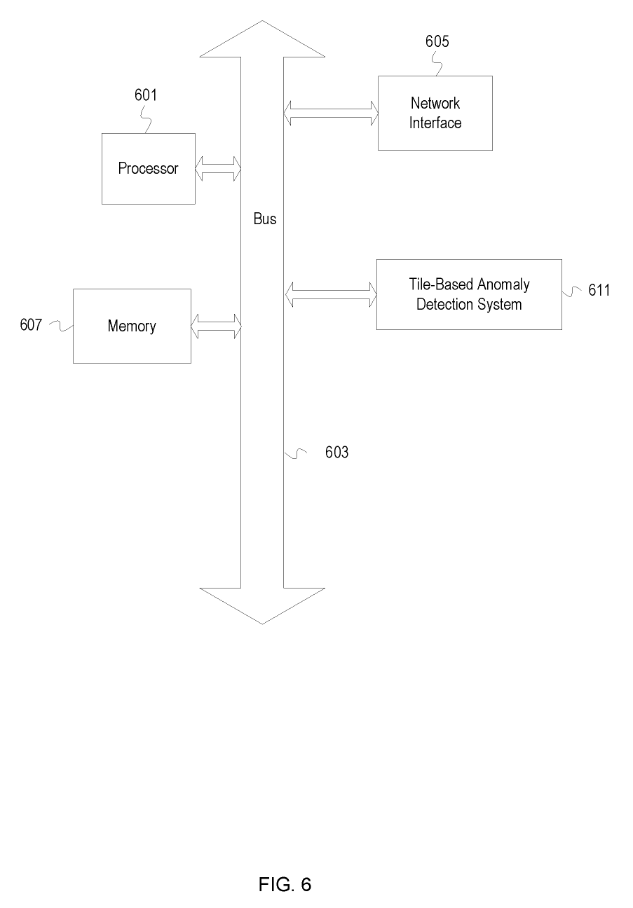

FIG. 6 depicts an example computer system with a tile-based anomaly detection system. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a tile-based anomaly detection system 611. The tile-based anomaly detection system 611 detects anomalies among application instances based on attempted reconstruction of time-series metric data. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for anomaly detection through attempted reconstruction of time-series metric data as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. The term “cloud destination” and “cloud source” refer to an entity that has a network address that can be used as an endpoint for a network connection. The entity may be a physical device (e.g., a server) or may be a virtual entity (e.g., virtual server or virtual storage device). In more general terms, a cloud service provider resource accessible to customers is a resource owned/manage by the cloud service provider entity that is accessible via network connections. Often, the access is in accordance with an application programming interface or software development kit provided by the cloud service provider.

This description uses the term “data stream” to refer to a unidirectional stream of data flowing over a data connection between two entities in a session. The entities in the session may be interfaces, services, etc. The elements of the data stream will vary in size and formatting depending upon the entities communicating with the session. Although the data stream elements will be segmented/divided according to the protocol supporting the session, the entities may be handling the data at an operating system perspective and the data stream elements may be data blocks from that operating system perspective. The data stream is a “stream” because a data set (e.g., a volume or directory) is serialized at the source for streaming to a destination. Serialization of the data stream elements allows for reconstruction of the data set. The data stream is characterized as “flowing” over a data connection because the data stream elements are continuously transmitted from the source until completion or an interruption. The data connection over which the data stream flows is a logical construct that represents the endpoints that define the data connection. The endpoints can be represented with logical data structures that can be referred to as interfaces. A session is an abstraction of one or more connections. A session may be, for example, a data connection and a management connection. A management connection is a connection that carries management messages for changing state of services associated with the session.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
generating a plurality of tiles based, at least in part, on first data collected from a plurality of component instances, wherein each of the plurality of component instances are instantiations of a same component;
attempting reconstruction of second data collected from a first component instance using one or more of the plurality of tiles; and
based on failing reconstruction of the second data, indicating that the first component instance is anomalous.

2. The method of claim 1, wherein generating the plurality of tiles based, at least in part, on the first data collected from the plurality of component instances comprises:
for each component instance of the plurality of component instances,
dividing time-series measurements in the first data related to the component instance into a plurality of segments, wherein each of the plurality of segments corresponds to a time period of the time-series measurements; and
for each segment of the plurality of segments,
determining values of one or more of the time-series measurements indicated at boundaries of the segment; and
storing the values as a tile.

3. The method of claim 2 further comprising:
identifying a plurality of metrics indicated in the time-series measurements; and
determining a first set of metrics from the plurality of metrics;
wherein determining values of one or more of the time-series measurements indicated at the boundaries of the segment comprises determining a value corresponding to each metric in the first set of metrics at the boundaries of the segment.

4. The method of claim 2, wherein dividing the time-series measurements in the first data related to the component instance into a plurality of segments comprises at least one of:
determining boundaries for each segment in the time-series measurements based on a time interval; and
determining boundaries for each segment of the plurality of segments to be located at every specified number of measurements in the time-series measurements.

5. The method of claim 1, wherein attempting reconstruction of the second data collected from the first component instance using one or more of the plurality of tiles comprises:
identifying one or more sets of values indicated in the second data; and
for each set of values of the one or more sets of values, determining whether a tile in the plurality of tiles comprises the set of values.

6. The method of claim 5 further comprising, based on determining that no tile in the plurality of tiles comprises the set of values, determining that reconstruction of the second data has failed.

7. The method of claim 1 further comprising, based on successful reconstruction of the second data, determining that the first component instance is behaving normally.

8. The method of claim 1, wherein the plurality of component instances comprises the first component instance, wherein tiles in the plurality of tiles generated based on data of the first component instance are excluded from the attempted reconstruction.

9. One or more non-transitory machine-readable media comprising program code, the program code to:
generate a plurality of tiles based, at least in part, on first data collected from a plurality of component instances, wherein each of the plurality of component instances are instantiations of a same component;
attempt reconstruction of second data collected from a first component instance using one or more of the plurality of tiles; and
based on failing reconstruction of the second data, indicate that the first component instance is anomalous.

10. The machine-readable media of claim 9, wherein the program code to generate the plurality of tiles based, at least in part, on the first data collected from the plurality of component instances comprises program code to:
for each component instance of the plurality of component instances,
divide time-series measurements in the first data related to the component instance into a plurality of segments, wherein each of the plurality of segments corresponds to a time period of the time-series measurements; and
for each segment of the plurality of segments,
determine values of one or more of the time-series measurements indicated at boundaries of the segment; and
store the values as a tile.

11. The machine-readable media of claim 10 further comprising program code to:
identify a plurality of metrics indicated in the time-series measurements; and
determine a first set of metrics from the plurality of metrics;
wherein the program code to determine values of one or more of the time-series measurements indicated at the boundaries of the segment comprises program code to determine a value corresponding to each metric in the first set of metrics at the boundaries of the segment.

12. The machine-readable media of claim 10, wherein the program code to divide the time-series measurements in the first data related to the component instance into a plurality of segments comprises program code to at least one of:
determine boundaries for each segment in the time-series measurements based on a time interval; and
determine boundaries for each segment of the plurality of segments to be located at every specified number of measurements in the time-series measurements.

13. An apparatus comprising:
a processor; and
a machine-readable medium having program code executable by the processor to cause the apparatus to,
generate a plurality of tiles based, at least in part, on first data collected from a plurality of component instances, wherein each of the plurality of component instances are instantiations of a same component;
attempt reconstruction of second data collected from a first component instance using one or more of the plurality of tiles; and
based on failing reconstruction of the second data, indicate that the first component instance is anomalous.

14. The apparatus of claim 13, wherein the program code to generate the plurality of tiles based, at least in part, on the first data collected from the plurality of component instances comprises program code to:
for each component instance of the plurality of component instances,
divide time-series measurements in the first data related to the component instance into a plurality of segments, wherein each of the plurality of segments corresponds to a time period of the time-series measurements; and
for each segment of the plurality of segments,
determine values of one or more of the time-series measurements indicated at boundaries of the segment; and
store the values as a tile.

15. The apparatus of claim 14 further comprising program code to:
identify a plurality of metrics indicated in the time-series measurements; and
determine a first set of metrics from the plurality of metrics;
wherein the program code to determine values of one or more of the time-series measurements indicated at the boundaries of the segment comprises program code to determine a value corresponding to each metric in the first set of metrics at the boundaries of the segment.

16. The apparatus of claim 14, wherein the program code to divide the time-series measurements in the first data related to the component instance into a plurality of segments comprises program code to at least one of:
determine boundaries for each segment in the time-series measurements based on a time interval; and
determine boundaries for each segment of the plurality of segments to be located at every specified number of measurements in the time-series measurements.

17. The apparatus of claim 13, wherein the program code to attempt reconstruction of the second data collected from the first component instance using one or more of the plurality of tiles comprises program code to:
identify one or more sets of values indicated in the second data; and
for each set of values of the one or more sets of values, determine whether a tile in the plurality of tiles comprises the set of values.

18. The apparatus of claim 17 further comprising program code to, based on a determination that no tile in the plurality of tiles comprises the set of values, determine that reconstruction of the second data has failed.

19. The apparatus of claim 13 further comprising program code to, based on successful reconstruction of the second data, determine that the first component instance is behaving normally.

20. The apparatus of claim 13, wherein the plurality of component instances comprises the first component instance, wherein tiles in the plurality of tiles generated based on data of the first component instance are excluded from the attempted reconstruction.
